(19) United States
(12) Patent Application Publication
(10) Pub. No.: US 2024/0357081 A1
(43) Pub. Date: Oct. 24, 2024

(54) Method and Apparatus for Hardware-Friendly Template Matching in Video Coding System

(71) Applicant: MEDIATEK INC., Hsinchu City (TW)

(72) Inventors: Chun-Chia CHEN, Hsinchu City (TW); Olena CHUBACH, San Jose, CA (US); Chih-Wei HSU, Hsinchu City (TW); Tzu-Der CHUANG, Hsinchu City (TW); Ching-Yeh CHEN, Hsinchu City (TW); Yu-Wen HUANG, Hsinchu City (TW)

(21) Appl. No.: 18/684,783

(22) PCT Filed: Aug. 18, 2022
(86) PCT No.: PCT/CN2022/113409

§ 371 Date: Feb. 19, 2024

Related U.S. Application Data
(60) Provisional application No. 63/234,736, filed on Aug. 19, 2021.

(51) Int. Cl. H04N 19/105; H04N 19/167; H04N 19/176; H04N 19/513

(52) U.S. Cl. CPC H04N 19/105; H04N 19/167; H04N 19/176; H04N 19/521

(57) ABSTRACT

A method and apparatus for video coding system that utilizes low-latency template-matching motion-vector refinement are disclosed. According to this method, input data associated with a current block of a video unit in a current picture are received. Motion compensation is then applied to the current block according to an initial motion vector (MV) to obtain initial motion-compensated predictors of the current. After applying the motion compensation to the current block, template-matching MV refinement is applied to the current block to obtain a refined MV for the current block. The current block is then encoded or decoded using information including the refined MV. The method may further comprise determining gradient values of the initial motion-compensated predictors. The initial motion-compensated predictors can be adjusted by taking into consideration of the gradient values and/or MV difference between the refined and initial MVs.

### CROSS REFERENCE TO RELATED APPLICATIONS

The present invention is a non-Provisional Application of and claims priority to U.S. Provisional Patent Application No. 63/234,736, filed on Aug. 19, 2021. The U.S. Provisional Patent Application is hereby incorporated by reference in its entirety.

### TECHNICAL FIELD

The present invention relates to video coding system. In particular, the present invention relates to efficient hardware implementation of template matching coding tool in a video coding system.

### BACKGROUND

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media-Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video coding system incorporating loop processing. For Intra Prediction, the prediction data is derived based on previously coded video data in the current picture. For Inter Prediction 112, Motion Estimation (ME) is performed at the encoder side and Motion Compensation (MC) is performed based of the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information.

Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder can use similar or portion of the same functional blocks as the encoder except for Transform 118 and Quantization 120 since the decoder only needs Inverse Quantization 124 and Inverse Transform 126. Instead of Entropy Encoder 122, the decoder uses an entropy decoder 140 to decode the video bitstream into quantized transform coefficients and needed coding information (e.g., ILPF information, Intra prediction information and Inter prediction information). The Intra prediction 150 at the decoder side does not need to perform the mode search. Instead, the decoder only need to generate Intra prediction according to Intra prediction information received from the Entropy Decoder 140. Furthermore, for Inter prediction, the decoder only needs to perform motion compensation (MC 152) according to Intra prediction information received from the Entropy Decoder 140 without the need for motion estimation.

According to VVC, an input picture is partitioned into non-overlapped square block regions referred as CTUs (Coding Trec Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

The VVC standard incorporates various new coding tools to further improve the coding efficiency over the HEVC standard. Among various new coding tools, some have been adopted by the standard and some are not. Among the new coding tools, a technique, named Template Matching, to derive the motion vector (MV) for a current block is disclosed. The template matching is briefly reviewed as follows.

Template Matching (TM)

Template matching (TM) has been proposed in JVET-J0021 (Yi-Wen Chen, et al., “Description of SDR, HDR and 360° video coding technology proposal by Qualcomm and Technicolor—ow and high complexity versions”, Joint Video Exploration Team (JVET) of ITU-T SG 16 WP 3 and ISO/IEC JTC 1/SC 29/WG 11, 10th Meeting: San Diego, US, 10-20 Apr. 2018, Document: JVET-J0021). Template Matching is a decoder-side MV derivation method to refine the motion information of the current CU by finding the closest match between a template (i.e., top and/or left neighbouring blocks of the current CU) in the current picture and a block in a reference picture as illustrated in FIG. 2. In FIG. 2, rows of pixels 214 above current block and columns of pixels 216 to the left of the current block 212 in the current picture 210 are selected as the template. The search starts from an initial position (as identified by the initial MV 230) in the reference picture. Corresponding rows of pixels 224 above the reference block 222 and columns of pixels 226 to the left of the reference block 222 in the reference picture 220 are identified as shown in FIG. 2. During the search, the same “L” shape reference pixels (i.e., 224 and 226) in different locations are compared with the corresponding pixels in the template around the current block. The location with minimum matching distortion is determined after the search. At this location, the block that has the optimal “L” shape pixels as its top and left neighbours (i.e., the smallest distortion) is selected as the reference block for the current block.

Since the template matching based refinement process is performed at both the encoder side and the decoder side, therefore the decoder can derive the MV without the need of signalled information from the encoder side. The Template Matching process derives motion information of the current block by finding the best match between a current template (top and/or left neighbouring blocks of the current block) in the current picture and a reference template (same size as the current template) in a reference picture within a local search region with search range [−8, 8] integer-pixel precision.

In AMVP (Advanced Motion Vector Prediction or Adaptive Motion Vector Prediction) mode, an MVP (Motion Vector Prediction) candidate is determined based on the template matching error to pick up the one which reaches the minimum difference between the current block and the reference block templates, and then TM performs only for this particular MVP candidate for MV refinement (i.e., local search around the initial MVP candidate). TM refines this MVP candidate, starting from full-pel MVD (Motion Vector Difference) precision (or 4-pel for 4-pel AMVR (Adaptive Motion Vector Resolution) mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on AMVR mode as specified in Table 1. This search process ensures that the MVP candidate still keeps the same MV precision as indicated by AMVR mode after TM process.

TABLE 1
Search patterns of AMVR and merge mode with AMVR.

| | AMVR mode | | | | | |
|---|---|---|---|---|---|---|
| Search | | Full- | Half- | Quarter- | Merge mode | |
| pattern | 4-pel | pel | pel | pel | AltIF = 0 | AltIF = 1 |
| 4-pel diamond | v | | | | | |
| 4-pel cross | v | | | | | |
| Full-pel | | v | v | v | v | v |
| diamond | | | | | | |
| Full-pel cross | | v | v | v | v | v |
| Half-pel cross | | | v | v | v | v |
| Quarter-pel | | | | v | v | |
| cross | | | | | | |
| ⅛-pel cross | | | | | v | |

In the merge mode, a similar search method is applied to the merge candidate indicated by the merge index. As shown in Table 1, TM may be performed all the way down to the ⅛-pel MVD precision or skip those beyond the half-pel MVD precision, depending on whether the alternative interpolation filter (that is used when AMVR is of half-pel mode) is used (as indicated by AltIF) according to merged motion information. Besides, when TM mode is enabled, template matching may work as an independent process or an extra MV refinement process between block-based and subblock-based bilateral matching (BM) methods, depending on whether BM can be enabled or not according to its enabling condition check. When BM and TM are both enabled for a CU, the search process of TM stops at the half-pel MVD precision and the resulted MVs are further refined by using the same model-based MVD derivation method as in DMVR (Decoder-Side Motion Vector Refinement).

According to the conventional TM MV refinement, if a current block uses the refined MV from a neighbouring block, this may cause a serious latency problem. Therefore, there is a need to resolve the latency problem and/or to improve the performance of TM refinement process.

### BRIEF SUMMARY

A method and apparatus for video coding system that utilizes low-latency template-matching motion-vector refinement are disclosed. According to this method, input data associated with a current block of a video unit in a current picture are received. Motion compensation is then applied to the current block according to an initial motion vector (MV) to obtain initial motion-compensated predictors of the current block. After applying the motion compensation to the current block, template-matching MV refinement is applied to the current block to obtain a refined MV for the current block. The current block is then encoded or decoded using information including the refined MV. The method may further comprise determining gradient values of the initial motion-compensated predictors. The initial motion-compensated predictors can be adjusted by taking into consideration of the gradient values of the initial motion-compensated predictors and/or MV difference between the refined and initial MVs.

In one embodiment, a bounding box in a reference picture is selected to restrict the template-matching MV refinement and/or the motion compensation to use only reference pixels within the bounding box. The bounding box may be equal to a region required for the motion compensation. The bounding box may also be larger than a region required for the motion compensation. For example, the bounding box may be larger than the region by a pre-defined size. If a target reference pixel for the template-matching MV refinement and/or the motion compensation is outside the bounding box, a padded value can be used for the target reference pixel. If a target reference pixel for the template-matching MV refinement and/or the motion compensation is outside the bounding box, the target reference pixel can also be skipped.

In one embodiment, horizontal gradient, vertical gradient or both are calculated for the gradient values. In one embodiment, the initial MV corresponds to a non-refined MV.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 illustrates an example of template matching, where rows of pixels above the current block and the reference block and columns of pixels to the left of the current block and the reference block are selected as the templates.

FIG. 3 illustrates an embodiment of the present invention, where a current CU uses information related to the original motion vector (MV) and refined MV of a neighbouring block to adjust the refined MV or motion-compensated predictors for the current block.

FIG. 4 illustrates an example of process flow of the batch processing MC, TM and gradient refinement according to an embodiment of the present invention.

FIG. 5 illustrates an examples of the extended L-shape template according to an embodiment of the present invention.

FIG. 6 illustrates a flowchart of an exemplary video coding system that utilizes template-matching motion vector refinement according to an embodiment of the present invention.

### DETAILED DESCRIPTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

As mentioned earlier, the TM refinement process requires to access the reference data for the templates. Furthermore, according to the conventional TM MV refinement, if a current block uses the refined MV from a neighbouring block, this may cause a serious latency problem. Therefore, there is a need to resolve the latency problem and/or to improve the performance of TM refinement process. In order to solve this issue, low-latency TM searching methods as well as an improved TM search method disclosed as follow.

### Gradient-Based MV Neighbour Propagation

In a TM implementation, if the current CU uses a neighbouring refined MV as the starting initial MV, this results in a serious latency problem, since the MV candidate required for the MV candidate list of the current CU cannot be generated until the MV refinement of the previous CU is done. The latency related to deciding the MV candidate list of the current CU will cause the coding system to slow down. Moreover, in a hardware codec, before deriving the MV of the current CU, the system must first wait for the MV refinement of the previous CU and then starts fetching reference data for the search-region and motion compensation (MC) from external memory, such as the DRAM (Dynamic Random Access memory). Therefore, this results in a very long latency.

In order to solve the latency issue related to the MV refinement, a method is proposed in the present invention. In one embodiment, the current CU uses a non-refined MV corresponding to one of the neighbouring CUs and performs MV candidate list reconstruction using this non-refined MV. Therefore, the CU can reconstruct the corresponding MV faster without waiting for the MV refinement process to complete. As is known in the existing video coding standard such as HEVC and VVC, the MV candidate list includes various types of MV candidate such as spatial MV candidates from neighbouring blocks of the current block and temporal MV candidate from collocated block in a reference picture. These types of MV candidates can be used as an initial MV and are examples of non-refined MV. After the TM refinement and MC is done for the current CU, the neighbouring refined MV corresponding to one of the neighbouring CUs is used to adjust the current refined MV result or the MC result. For example, if the current CU originally uses the MV of the top neighbouring CU, the current CU will now use the refined MV of the top neighbouring CU to perform the adjustment. In yet another embodiment, only after the MC is done for the current CU, the neighbouring refined MV corresponding to one of the neighbouring CUs is used to adjust the MC result, where the MC results refers to the motion-compensated predictor block or the motion-compensated predictors for pixels of the current block.

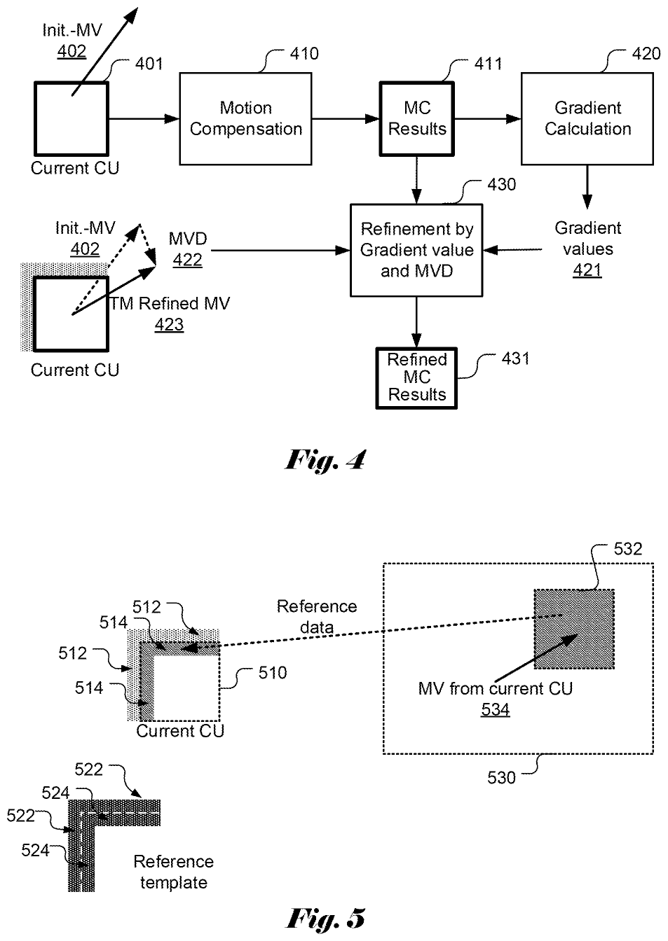

An example of the proposed method is shown in FIG. 3, where block 310 corresponds to a current CU and block 320 corresponds to a previous CU. Each CU has an original MV (OriMV) and a refined MV (RefMV). The motion vector difference (MVD) for a CU is defined as MVD =RefMV-OriMV. An exemplary process according to an embodiment of the present invention is shown in flowchart 330. In step 332, an MV candidate list is constructed using OriMV instead of RefMV of the previous CU. Therefore, the current block does not need to wait for the refinement process. In step 334, the TM search and MC, or only the MC is applied to the current CU. When RefMV of the previous CU becomes available, the MVD of the previous CU can be determined and used for refinement or adjustment of the current CU as shown in step 336. The adjustment of the MC results (i.e., the MC predictors) based on the MVD is according to a gradient-based method. As is known in the field, the gradient (also called derivative) of a function is defined as the rate of change of the function. In other words, the rate of change in the function (i.e., the MC predictor) is according to the MV defference.

There are multiple embodiments of how to perform neighbouring CU's MV refinement for the current CU (i.e., the step 336 in FIG. 3).

In one embodiment, the MVD of the neighbouring MV (named as neiMV) can be added to the refinement result of the current CU, where the MVD (named as neiMVD) is the MV difference between the refined MV and the initial MV (or the original MV) of the previous CU. In one embodiment, it is proposed to perform some scaling first, and then add the result of scaling to the MV of the current CU. For example,

$$MV ’ = refMV + alpha * neiMVD ,$$

where MV′ is the adjusted MV of the current CU, refMV is the TM refined MV of the current CU, neiMVD is the MVD of the neighbouring CU, alpha is a scaling factor.

The value of alpha can be equal to 1. However, alpha can also depend on the ambiguity of the current refined MV. For example, if the distortions computed at all searching points are similar after performing the TM search for the current CU, then the distortion at the best position is not much smaller than of other positions (i.e., more ambiguity). In this case, alpha is assigned to be 1. If the current TM search shows that the distortion computed at the best position is much lower than the computed distortions at other positions (i.e., less ambiguity), alpha can be assigned to a smaller value (e.g., alpha=0.5 or lower).

In another embodiment, the refined MV of the current CU (e.g., obtained after TM refinement of the current CU) is added to the MVD′ first, where MVD′ corresponds to the MVD of the neighbouring CU. If the new position (i.e., current CU refined MV+MVD′) has a much larger distortion compared to the refined MV before adding MVD', then there is no need to add the MVD′ (i.e., keeping the original refinement result). In one embodiment, the distortion at the new position is evaluated according to the TM distortion (i.e., the differences between the reference template and the current template).

In another embodiment, the method to reduce the latency related to TM search and/or MC is similar to the previously described ones. However, instead of adjusting the refined MV, it is proposed to adjust the MC results, where the MC results corresponds to the MC predictor generated after deriving the refined MV of the current CU. In one embodiment, the goal is to obtain the adjustment of the MC results (i.e., to refine the MC predictors). In one embodiment, the refinement (or adjustment) is obtained by using the horizontal and vertical gradients of the MC result, and the MVD from the neighbouring CU.

### Batch Processing of MC->TM->Gradient Refinement

The benefit of this proposed method is to reduce the latency so that MC and MV refinement can be done in parallel (i.e., batch processing). In this proposed method, instead of performing a refinement of the current CU's MV prior to the MC, as is done in the conventional TM search algorithm, the MC is performed prior to the MV refinement. In other words, an initial MV is used to derive the MC predictors first, and then the TM-based MV refinement can then be performed. As mentioned earlier, a non-refined MV can be used as the initial MV so that the current CU does not need to wait for the completion of the MV refinement process.

In one embodiment, when the TM-based MV refinement is done, the MVD (i.e., the difference between the current refined MV and the initial MV) can be used to refine the MC predictor pixels. In one embodiment, the refinement can be based on the gradient values of the MC results.

FIG. 4 illustrates an example of process flow of the batch processing MC, TM and gradient refinement according to an embodiment of the present invention. In FIG. 4, the current CU 401 and an initial MV 402 are provided as inputs to Motion Compensation 410 to generate MC Results 411. The MC Results 411 is used by Gradient Calculation 420 to generate Gradient values 421. On the other hand, TM refinement can be applied to the current CU 402 with the initial MV 402 to derive a refined MV 423. The MVD 422 can be calculated as the difference between the refined MV 423 and the initial MV 402. The MC results, the Gradient values 421 and the MVD 422 are provided to Refinement by Gradient values and MVD 430 to derive Refined MC Results 431.

This method can also be combined with the bounding box method, where the bounding box is used to restrict the reference data access for TM searching and/or MC predictors. In one embodiment, the bounding box can be the defined to be equal to the region required for MC. In another embodiment, the bounding box is extended beyond the region required for MC (e.g., a pre-defined size larger than the region required for MC). When performing the TM search and/or MC, only the pixels within the bounding box are used. If the required pixels are outside of the bounding box, various techniques can be used, such as skipping the TM candidate or padding the values outside of the bounding box.

One example of the proposed method is described below. As the first step, the traditional MC is performed according to the initial MV of the current CU. Since the initial MV of the current CU is used, we can obtain the MC results of several CUs in parallel without waiting for the refinement results. Then we perform the TM MV refinement using the reference pixels from the bounding box of the region required for the MC (i.e., the pixel region used to interpolate the MC results).

If the TM refinement pixels exceed the bounding box (i.e., outside the bounding box), we can skip the candidate pixels or use the padded pixels. In the final step, we calculate the gradient values (horizontal gradients, vertical gradients, or both) of the MC predictor, and obtain the pixel adjustment of the MC results using the gradient values and the MV difference (between the refined and the initial MVs).

### Extended L-shape Template by Predictor

The original L-template of the current CU (in the current picture) conventionally contains pixels outside of the current CU (normally neighbouring to the current CU). In this proposed method, the L-template of the current picture can be extended to the inside of the current CU. Thus, it will include some additional inner L-shape pixels of the block. In one embodiment of the proposed method, some MC predictor results can be added to the current template. In other words, we combine some MC predictor pixels (without MV refinement, using the original MV) and the current L-template to form a new current-CU L-template. As a result, the new current L-template will contain more pixels, compared to the conventional current L-template. Then, the new current L-template is compared to the reference L-template (also extended to be the same size compared to current L-template). In one embodiment, the number of lines of the MC predictors, which are combined with the current L-template (i.e., outer-pixels of current CU), is pre-defined. In another embodiment, this number of lines is adaptive according to the CU size. In another embodiment, this number of lines depends on the POC (picture order count) distance between the current picture and the reference picture. In another embodiment, this number of lines depends on the temporal Id (TId) of the current and/or reference picture (e.g. increasing with increased Tld).

FIG. 5 illustrates an examples of the extended L-shape template according to an embodiment of the present invention. The dashed box 510 corresponds to the current CU. The L-shaped template 512 outside the current CU corresponds to the conventional L-shaped template. The extended L-shaped template 514 is the inside L-shaped template. Since these inside L-shaped template pixels of the current CU are not coded yet, they are obtained from a reference picture. A corresponding CU 532 (or collocated CU) is located using an MV 534 of the current CU, where the MV 534 points from the current CU 510 to the collocated CU 532 in the reference picture 530. The reference data from the collocated CU 534 are retrieved and used as the inside L-shaped template. The reference template also needs to be extended to include the original outside L-shaped template 522 and the corresponding inside L-shaped template 524.

In one embodiment, to make the current L-template better (e.g. better for matching), we can improve the “combined” template (where combined template=outer pixel L-shape+inner predictor-based L-shape).

Some embodiments are described below. When the outer L-template comes from the reconstructed neighbouring pixels and the inner L-template comes from the MC prediction, pixels between these two template parts should be removed if there is a discontinuity between these two template parts.

In one embodiment, filtering is applied to the “combined” current L-template. The filtering process can be an FIR (finite-impulse-response) based linear filter or other kinds of filter. After filtering of the “combined” template, the discontinuity between the outer L-template and inner L-template can be reduced.

In another embodiment, the reconstructed residual is added to the inner L-template. In the conventional decoder, the residual data are inverse-transformed from the decoded frequency domain transform coefficients and added to the MC results. In one embodiment of the proposed method, we can add the decoded residual samples to the inner-L-template so as to make the inner-L-template more real, and remove the discontinuity between the outer and inner L-templates.

In another embodiment, it is proposed to perform several rounds of TM search. In each round, the combined L-template is the outer neighbouring reconstructed pixels plus the inner MC predictor obtained by the refined MV from the previous round. In one embodiment, we have two rounds of TM search; and in the second round, the inner MC predictor (for the combined L-shape) will be obtained based on the refined MV result from the first round. This can be extended to the case of N rounds, where in round N:

Combined L=outer-reconstruct+inner-MC(MC according to RefMV (N−1)).

In the above equation, refMV (N-1) is the refined MV result after the TM search in round (N-1). In another embodiment, the number of rounds is decided at the encoder side, and information regarding the number is signalled to the decoder (e.g. signalled for each CU in slice/picture header or PPS). In another embodiment, the number of rounds depends on the POC distance/TId of the current and/or reference frame/CU size.

Searching Only One List MVP In the TM-AMVP algorithm as disclosed in JVET-U0100 (Yao-Jen Chang, et al., “Compression efficiency methods beyond VVC”, Joint Video Exploration Team (JVET) of ITU-T SG 16 WP 3 and ISO/IEC JTC 1/SC 29/WG 11, 21st Meeting, by teleconference, 6-15 Jan. 2021, Document: JVET-U0100), when Bi-pred is used, TM is performed for both, L0 and L1 MVP candidates. To reduce the external memory bandwidth, it is proposed to perform TM only for L0 or L1, and perform no TM on the other (opposite) list.

In another embodiment, when uni-to-bi conversion is performed, it is proposed to refine only the “fake” MVP. Since during the conversion, uni-MVP is just reverted (i.e., using-MVP or negative MVP) and the refIdc is always assigned to 0, regardless of the real uni-directional

MVP's refIdc. Thus, the “fake” MVP is less precise and probably needs refinement more than the “original” uni-directional MVP.

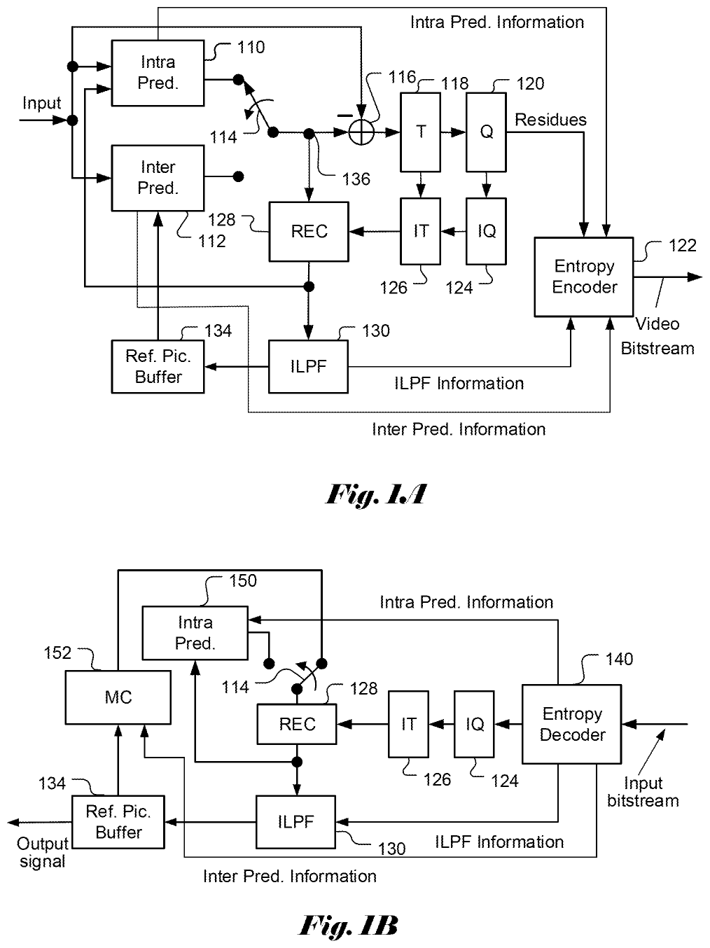

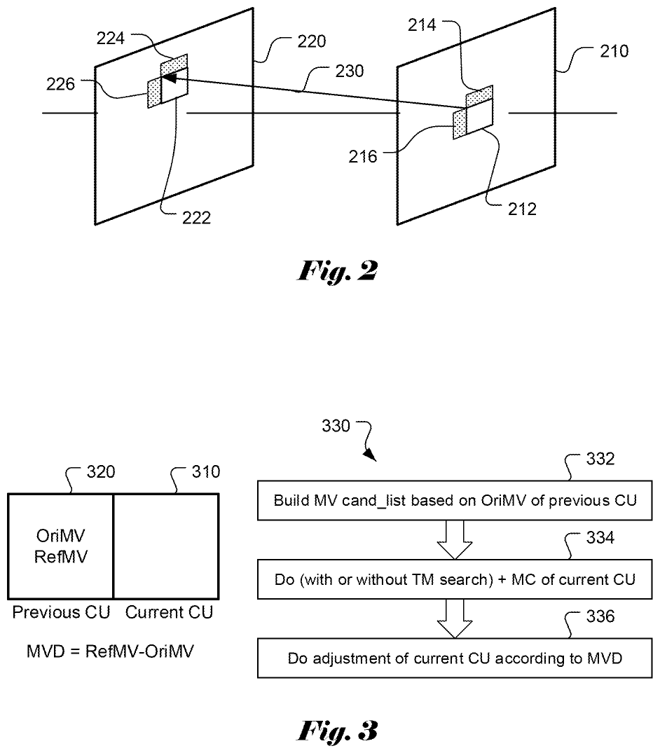

The template matching MV refinement can be used as an inter prediction technique to derive the MV. The template matching MV refinement can also be used to refine an initial MV. Therefore, template matching MV refinement process is considered as a part of inter prediction. Therefore, the foregoing proposed methods related to template matching can be implemented in the encoders and/or the decoders. For example, the proposed method can be implemented in an inter coding module (e.g., Inter Pred. 112 in FIG. 1A) of an encoder, and/or an inter coding module (e.g., MC 152 in FIG. 1B) of a decoder.

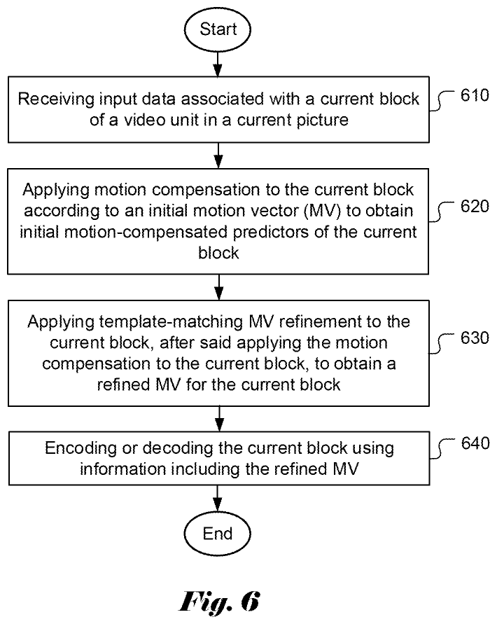

FIG. 6 illustrates a flowchart of an exemplary video coding system that utilizes template-matching (TM) motion vector (MV) refinement according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, input data associated with a current block of a video unit in a current picture are received in step 610. Motion compensation is applied to the current block according to an initial motion vector to obtain initial motion-compensated predictors of the current block in step 620. Template-matching MV refinement is applied to the current block in step 630 after said applying the motion compensation to the current block, to obtain a refined MV for the current block. The current block is encoded or decoded using information including the refined MV in step 640.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data associated with a current block of a video unit in a current picture;
applying motion compensation to the current block according to an initial motion vector (MV) to obtain initial motion-compensated predictors of the current block;
applying template-matching MV refinement to the current block after said applying the motion compensation to the current block, to obtain a refined MV for the current block; and
encoding or decoding the current block using information including the refined MV.

2. The method of claim 1, further comprising determining gradient values of the initial motion-compensated predictors.

3. The method of claim 1, said encoding or decoding the current block comprises adjusting the initial motion-compensated predictors based on information including gradient values of the initial motion-compensated predictors or an MV difference (MVD) between the refined MV and the initial MV to generate adjusted motion-compensated predictor.

4. The method of claim 3, wherein the initial motion-compensated predictors are adjusted based on the MV difference.

5. The method of claim 3, wherein the initial motion-compensated predictors are adjusted based on the gradient values of the initial motion-compensated predictors.

6. The method of claim 1, wherein a bounding box in a reference picture is selected to restrict the template-matching MV refinement and/or the motion compensation to use only reference pixels within the bounding box.

7. The method of claim 6, wherein the bounding box is equal to a region required for the motion compensation.

8. The method of claim 6, wherein the bounding box is larger than a region required for the motion compensation.

9. The method of claim 8, wherein the bounding box is larger than the region by a pre-defined size.

10. The method of claim 6, wherein if a target reference pixel for the template-matching MV refinement and/or the motion compensation is outside the bounding box, a padded value is used for the target reference pixel.

11. The method of claim 6, wherein if a target reference pixel for the template-matching MV refinement and/or the motion compensation is outside the bounding box, the target reference pixel is skipped.

12. The method of claim 1, wherein horizontal gradient, vertical gradient or both are calculated for the gradient values of the initial motion-compensated predictors.

13. The method of claim 1, wherein the initial MV corresponds to a non-refined MV.

14. An apparatus of video coding, the apparatus comprising one or more electronic circuits or processors arranged to:
receive input data associated with a current block of a video unit in a current picture;
apply motion compensation to the current block according to an initial motion vector (MV) to obtain initial motion-compensated predictors of the current block;
apply template-matching MV refinement to the current block after the motion compensation is applied to the current block, to obtain a refined MV for the current block; and
encode or decode the current block using information including the refined MV.
